(19) United States
(12) Patent Application Publication
(10) Pub. No.: US 2008/0308651 A1
(43) Pub. Date: Dec. 18, 2008

(54) HAND HELD CAR WASH NOZZLE AND A SYSTEM FOR USING THE SAME

(76) Inventor: Troy Gerald Diskin, Newaygo, MI (US)

Correspondence Address: LAMPEL & ASSOCIATES, P.C., 555 SKOKIE BLVD., SUITE 500, NORTHBROOK, IL, 60062, US

(21) Appl. No.: 12/047,396

(22) Filed: Mar. 13, 2008

Related U.S. Application Data
(60) Provisional application No. 60/906,799, filed on Mar. 13, 2007.

(51) Int. Cl. B05B 1/28

(52) U.S. Cl. 239/291

(57) ABSTRACT

The present invention is designed to fill a gap in the self-serve car wash process. Up until now customers at a self-serve car wash would be forced to use an ‘inferior’ drying system, located within a bay or outside, somewhere on the car wash property, or use and expensive drive-thru automatic nozzle system, or such manual means as a towel or chamois, to complete the drying cycle of the self-serve car wash process. The present apparatus addresses the new refinements and innovations leading to a self-serve hand-held nozzle system that has an improved overall performance, increased mechanical durability, reduced cost of manufacture, and an easy to use, ergonomic design, allowing for increased comfort and simplistic operation. In addition, the hand held nozzle has a first handle and a second handle. The first handle may rotate with respect to the second handle. When the first handle and the second handle are in a first position air may flow out of a first end of the nozzle. While the first handle and the second handle are in a second position, air may flow out of a side slit opening of the nozzle. The user may easily rotate the nozzle from the first position to the second position thereby altering the path air exists from the dyer. The device also may have an automatic shut off button which automatically shuts off the device if not pressed during operation.

This application is based on, and claims the filing date benefit of, U.S. provisional patent application No. 60/906,799 filed on Mar. 13, 2007.

### BACKGROUND

The present invention is designed to fill a gap in the self-serve car wash process. Up until now customers at a self-serve car wash would be forced to use an ‘inferior’ drying system, located within a bay or outside, somewhere on the car wash property, or use and expensive drive-thru automatic nozzle system, or such manual means as a towel or chamois, to complete the drying cycle of the self-serve car wash process. The present apparatus addresses the new refinements and innovations leading to a self-serve hand-held nozzle system that has an improved overall performance, increased mechanical durability, reduced cost of manufacture, and an easy to use, ergonomic design, allowing for increased comfort and simplistic operation. In addition, the hand held nozzle has a first handle and a second handle. The first handle may rotate with respect to the second handle. When the first handle and the second handle are in a first position air may flow out of a first end of the nozzle. While the first handle and the second handle are in a second position, air may flow out of a side slit opening of the nozzle. The user may easily rotate the nozzle from the first position to the second position thereby altering the path air exists from the dyer. The device also may have an automatic shut off button which automatically shuts off the device if not pressed during operation.

Previous nozzles systems are known in the art; however, these previous nozzles lack the functionality of the herein described invention. More specifically, these previous nozzles often have problems with, for example, their manufacture, operation, or use; low volume of exhaust air, low exit speed of the air, improper maintaining of pressure to maintain proper exhaust speed and volume, reduction of the lifespan of the motor assemblies or blower units, manifold, hose assembly, and nozzle assembly, etc., due to production of mechanical and thermodynamic stress, expensive materials used in the manufacture of the nozzle units, large or bulky hose assemblies that prevent ease of use, improper design of the hose/nozzle assembly leading to poor handling qualities and ease of use.

### SUMMARY OF THE INVENTION

The present invention is designed to fill a gap in the self-serve car wash process. Up until now customers at a self-serve car wash would be forced to use an ‘inferior’ drying system, located within a bay or outside, somewhere on the car wash property, or use and expensive drive-thru automatic nozzle system, or such manual means as a towel or chamois, to complete the drying cycle of the self-serve car wash process. The present apparatus addresses the new refinements and innovations leading to a self-serve hand-held nozzle system that has an improved overall performance, increased mechanical durability, reduced cost of manufacture, and an easy to use, ergonomic design, allowing for increased comfort and simplistic operation. In addition, the hand held nozzle has a first handle and a second handle. The first handle may rotate with respect to the second handle. When the first handle and the second handle are in a first position air may flow out of a first end of the nozzle. While the first handle and the second handle are in a second position, air may flow out of a side slit opening of the nozzle. The user may easily rotate the nozzle from the first position to the second position thereby altering the path air exists from the dyer. The device also may have an automatic shut off button which automatically shuts off the device if not pressed during operation.

This invention corrects the following problems found in the prior art. More specifically, the present invention provides a nozzle having multiple handles thereby allowing the user to more easily and securely operate the nozzle.

A further advantage of the present invention is to provide a nozzle which allows the user to easily alter the direction of the flow of air out of the nozzle in direction.

A still further advantage of the present invention is to provide a nozzle which allows the user to easily alter the shape of the air flow exiting the nozzle.

And yet another advantage of the present invention is to provide a nozzle wherein the nozzle quickly automatically shuts off if the user drops or otherwise stops using the apparatus.

And still another advantage of the present invention is to provide a nozzle wherein the air flow exiting the nozzle is consistently spread throughout the opening of the nozzle.

A need therefore exists for the improved hand nozzle of the present invention.

### BRIEF DESCRIPTION OF THE DRAWINGS

FIG. 1 illustrates a perspective view of the swivel of the present invention.

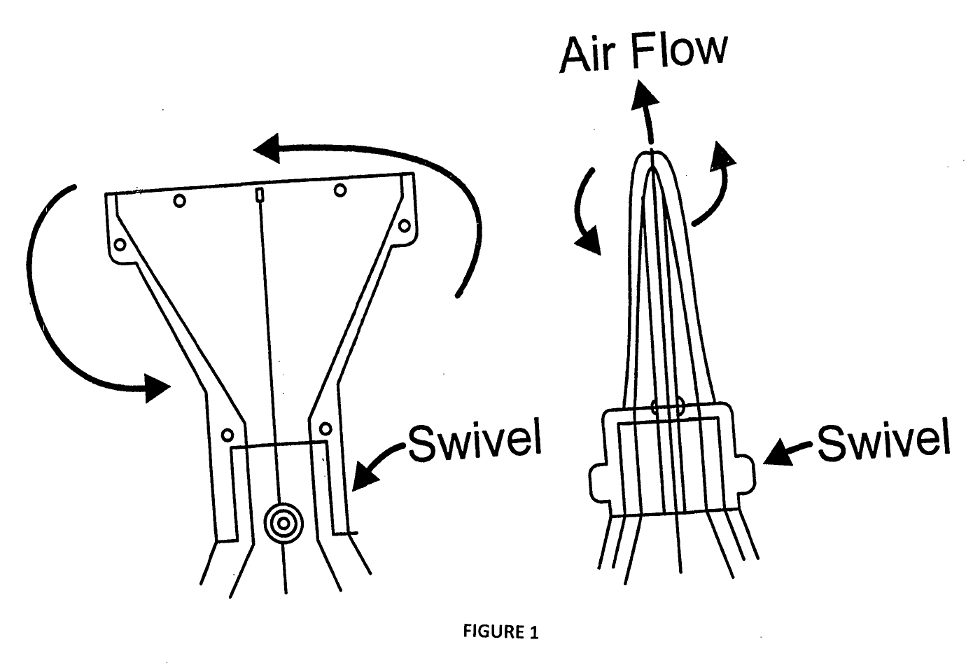

FIG. 2 illustrates a side perspective view of the present invention.

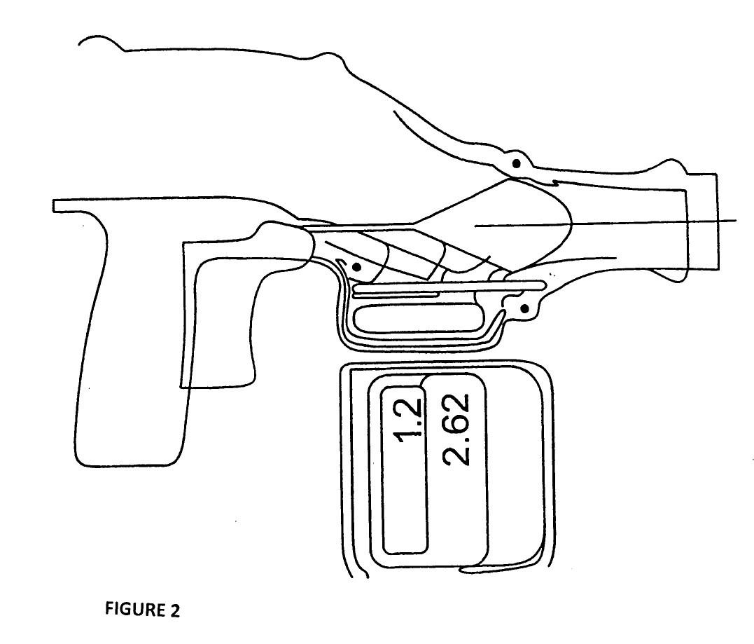

FIGS. 3a-3d illustrates the second cylindrical tube of the nozzle.

FIG. 4 illustrates a side perspective view of the second cylindrical tube of the present invention.

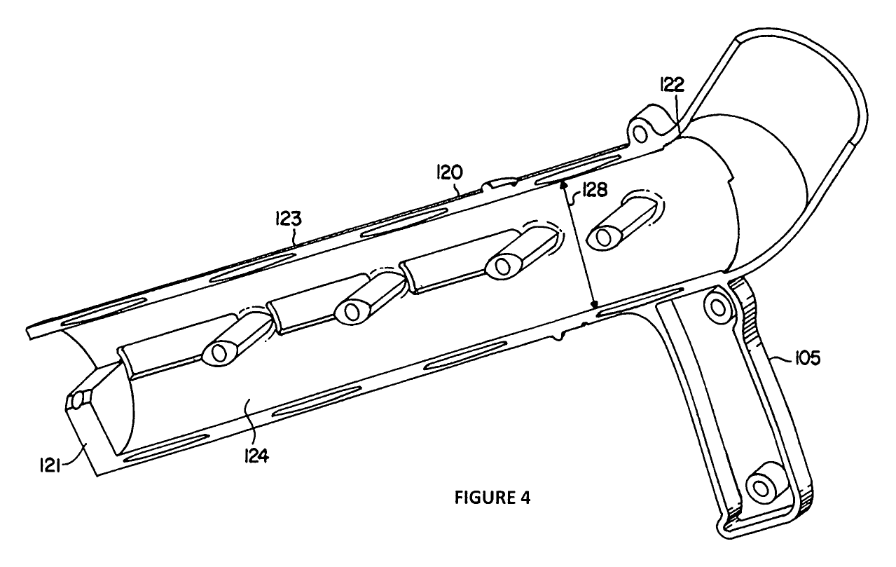

FIG. 5 illustrates a side interior view of the second cylindrical tube of the present invention.

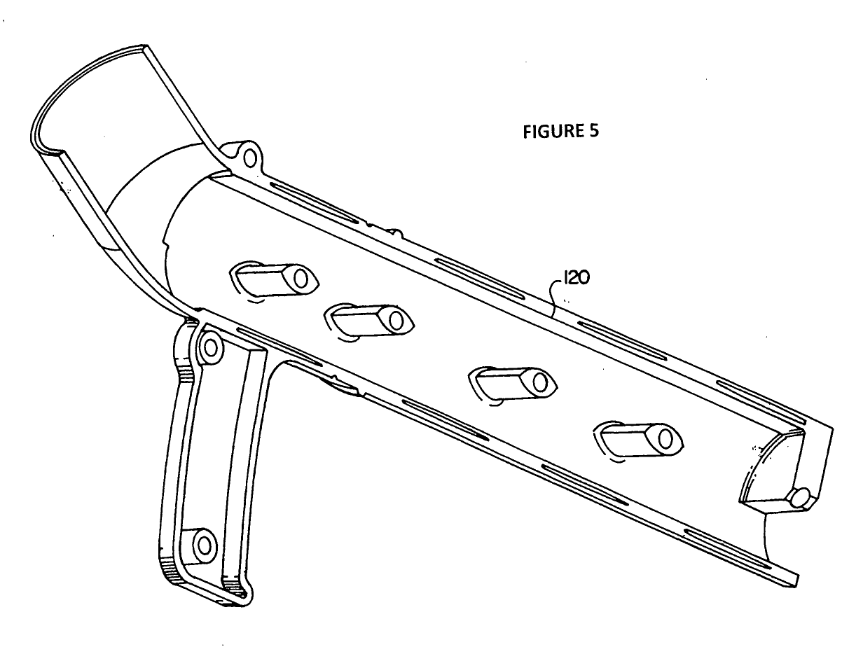

FIGS. 6a-6d illustrates perspective views of the first cylindrical tube of the present invention.

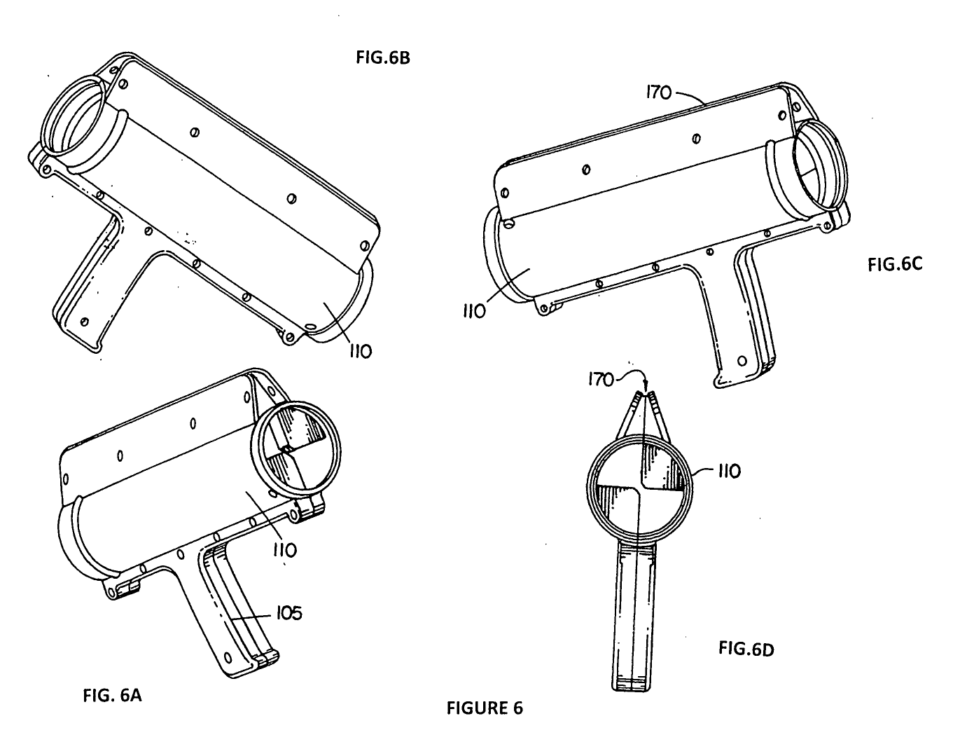

FIG. 7 illustrates the exterior of the first cylindrical tube of the present invention.

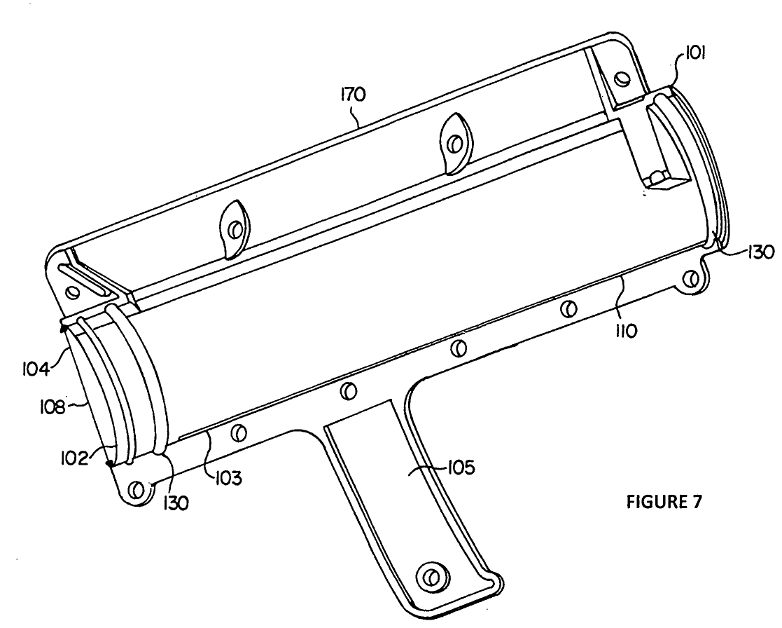

FIG. 8 illustrates the exterior of the first cylindrical tube of the present invention.

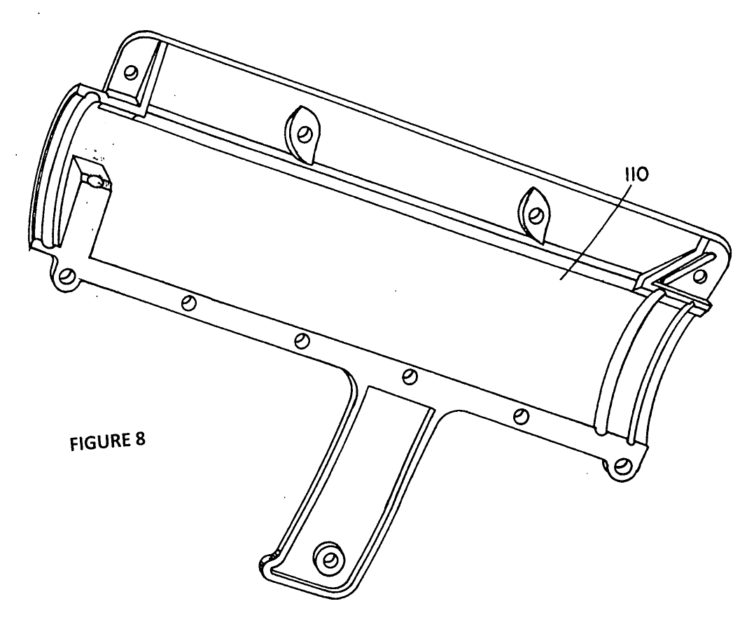

FIGS. 9a-9d illustrates the nozzle of the present invention wherein the first cylindrical tube is inserted over the second cylindrical tube.

FIG. 10 illustrates an interior view of the present invention wherein the first cylindrical tube is inserted over the second cylindrical tube.

FIG. 11 illustrates a perspective view of the present invention.

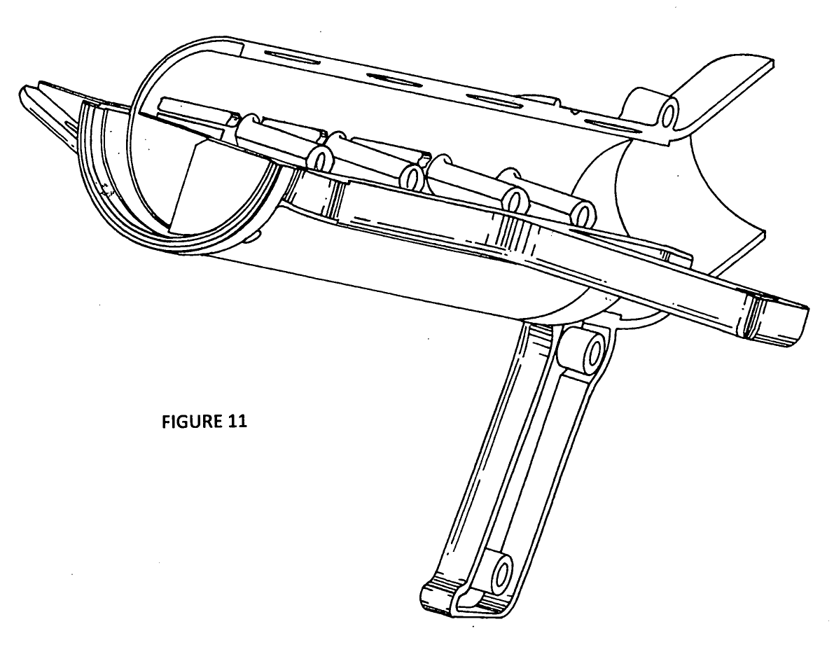

FIG. 12 illustrates the movement of the first cylindrical tube with respect to the second cylindrical tube.

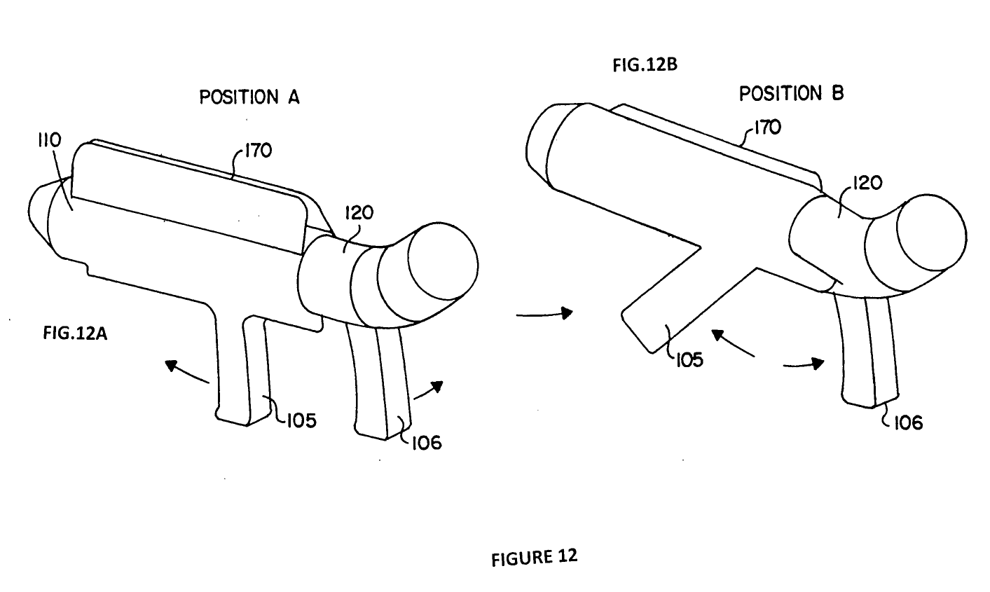

### DETAILED DESCRIPTION OF THE PRESENTLY PREFERRED EMBODIMENTS

The present invention is designed to fill a gap in the self-serve car wash process. Up until now customers at a self-serve car wash would be forced to use an ‘inferior’ drying system, located within a bay or outside, somewhere on the car wash property, or use and expensive drive-thru automatic nozzle system, or such manual means as a towel or chamois, to complete the drying cycle of the self-serve car wash process. The present apparatus addresses the new refinements and innovations leading to a self-serve hand-held nozzle system that has an improved overall performance, increased mechanical durability, reduced cost of manufacture, and an easy to use, ergonomic design, allowing for increased comfort and simplistic operation. In addition, the hand held nozzle has a first handle and a second handle. The first handle may rotate with respect to the second handle. When the first handle and the second handle are in a first position air may flow out of a first end of the nozzle. While the first handle and the second handle are in a second position, air may flow out of a side slit opening of the nozzle. The user may easily rotate the nozzle from the first position to the second position thereby altering the path air exists from the dyer. The device also may have an automatic shut off button which automatically shuts off the device if not pressed during operation.

In order to properly dry the surface of a vehicle in an efficient manner, the proper volume of air must be present at the exhaust point of the system. During testing it was found that approximately 250 to 450 cfm of air would provide efficient drying of the surface. In order to attain this volume, a series of three higher amperage motors are used each producing between 90 and 110 cfm of airflow (depending on barometric pressure, humidity, temperature and other environmental factors), and are arranged in a parallel flow system to generate the necessary 250-300 cfm of airflow.

In order to properly dry the surface of a vehicle in and efficient manner, the exit speed of the airflow must be above 150 mph. It has been proven that 90 mph air speed will sufficiently dry a surface where the water is in a beaded state such as on a waxed vehicle. However, since this is not always the case, it has been determined that the airflow must be able to blow off water that is in a layered or sheeted state, as is the case with many no-waxed vehicles. Through testing it has been shown that air speeds of 150 to 350 mph are sufficient to adequately dry a non-waxed or dirty surface where the water behaves in a sheeting manner. Through a combination of matching motor performance, maintaining proper internal line pressure, and allowing for proper exit flow dynamics at the nozzle assembly, the higher air speeds necessary for efficient drying can be maintained.

In order to properly dry the surface of a vehicle in an efficient manner, it has been stated that the proper combination of air speed and airflow volume must be met. Air speed and airflow volume are important to achieving the needed performance of the system. Since these two variables are inter-related a third variable is needed to create a balanced system. This third variable, line pressure, is manipulated to create a balance between airflow volume and air exit speed. The higher the line pressure, the higher the exit speed, but because we have finite intake volume, the higher line pressure reduces the airflow volume, and vice versa. Through testing, it has been shown that an internal line pressure of between 3 and 5 psi is necessary to create a working balance between airflow volume and air exit speed. This is achieved through the use of increased blower motor capacity and a reduction in nozzle exit area to generate a pressure zone (pressurized to between 3 and 5 psi) existing within the hose assembly after the motor series and before the nozzle exit orifice.

In order to properly dry the surface of a vehicle in an efficient manner, all of the aforementioned requirements must be maintained. Due to the increases in airflow requirements, exit airspeed requirements, and internal line pressure requirements, certain mechanical stresses arise within the system. Stresses such as increase in heat production due to compressional warming near the motor series, overall increase component stress due to the increase line pressure, and a ‘hammering’ effect created when the exit hole of the nozzle is blocked either intentionally or as a function of the system, all combine to lower the lifespan of the individual components including the blower motors, manifold, seals, line assembly, and the assembly, etc. There are several ways to relieve these stresses created during normal. Operation and use. Allowing the nozzle end to remain open at all times, including the use of holes perpendicular to the flow located at the nozzle tip (such as found approved high pressure blow of guns etc.) would reduce the overall stresses on the system, but would allow the hose assembly to snake around when not held securely, especially at the higher airflow and airspeed requirements of the system. Allowing the nozzle assembly to leak in a manner so the force of the escaping air is equally distributed thus canceling any one directive force is also a solution. This solution, however, would create unnecessary noise and airflow near the nozzle reducing the comfort to the user.

In another solution, as is the case of the preferred embodiment, a relief valve could be located somewhere between the blower motor series and the nozzle assembly to allow the pressurized air, heat, or backflow (shock) to escape when the airflow is blocked (either intentionally or as a feature of the system).

Another way to relieve the mechanical stresses generated during normal operation would be to manufacture the entire flow system that is everything from the blower series to the nozzle assembly, out of materials that would withstand the increases in mechanical and thermodynamic stresses. Since most of the available plastics such as polyethylene, poly vinyl chloride (PVC), polystyrene, polypropylene, etc. ether have too low a deflection temperature, or too high a price to be economically viable, the entire system would have to be assembled out of metals or other sturdy materials that would only serve to increase production and increase maintenance cost.

As stated previously, the preferred embodiment uses a relief valve system that allows for the reduction of mechanical and thermodynamic stresses. It has been proven in testing that these stresses can be lowered sufficiently to allow the use of cheaper, readily available plastics such as polyethylene, poly vinyl chloride (PVC) and common polyurethane plastics and rubbers in the construction of the nozzle systems, thus reducing overall cost of production and subsequent cost of maintenance.

There is another way to increase the overall performance of nozzle systems that requires the use of larger diameter hose assemblies to increase the overall airflow volume while maintaining speed and pressure. This idea of increasing the overall diameter of the hose assembly has been found to be inferior for two reasons. The first is that the overall increase in size of the hose is also accompanied by increase in stiffness and bulkiness that leads to a reduction in ease of operation while in use. The other reason is the fact that while larger hose assemblies can be found in many different sizes and material, they are generally more expensive in the larger sizes or unavailable in a size needed to maintain some level of comfort when in use.

It has been discovered over the past year that a nozzle that is ergonomically correct will be used more than a nozzle that is not correct. This means that the proper nozzle will generate more revenue for the car wash owner, in terms of minutes used by the car wash user.

The present car dryer nozzle has eight unique features which help our drying system operate more effectively and superior to other products.
1. Our nozzle uses an on/off trigger. As the trigger is pulled, it releases the pressurized air. Because the car wash user is holding the nozzle the nozzle will not go out of control and “snake around” inside of the bay.
2. Our nozzle has an automatic shut off feature that prevents the over pressurized hose and nozzle from “snaking around” inside of the bay, which could potentially harm the user or damage the vehicle inside of the car wash bay. In order to achieve this we use the air pressure to close the valve automatically if the nozzle is accidentally dropped by the car wash user. We have also used a spring to assist the closing of the valve.
3. It has been found that when the trigger valve closes the air stream to prevent air from moving through the hose the motors begin to overheat. To prevent parts melting and motors over heating we have incorporated a relief valve into our system. When the trigger shuts itself off the relief valve opens relieving the heat from the system.
4. A new variation of this nozzle will incorporate the relief valve into the nozzle itself. Currently we use 2 separate parts. The nozzle is one separate part and the relief valve is another separate part. The 2 parts could easily be combined into the same part as one nozzle assembly.
5. We have learned that car wash users and owners prefer 2 different types of nozzle tips or outlets that effectively dry the car. OPTION 1: The first tip is a one inch diameter outlet hole that allows a higher volume of air to strike the surface of the vehicle. This higher volume of air creates more of a blast effect which dries one spot of the car faster with increased air speed. Another way to say this is, by using a 1 inch diameter orifice it will increase the air speed but decrease the drying surface area. OPTION 2: The second option is to dry the car using an air knife effect. This method of drying reduces the air speed but increases the drying surface area. Another feature we have built into the nozzle is to allow the fan tip to swivel 360 degree's to allow for ease of operation by the car washer.
6. Our nozzle uses the same gun, with interchangeable nozzle attachments to accommodate the car washer's preference. Our customers can choose either a fan tip or a diameter outlet when they order our product.
7. Previous nozzles used a 24 volt on/off switch. Because our on/off switch is mechanical it avoids the use of an electrical switch. This previously used switch is constantly exposed to the harsh environment of a car wash, and malfunctions often. Also a 24 volt wire must be run from the switch on the gun to the relays. This 24 volt wire is run through the hose to relays on the motor set, which is inconvenient for the installer and creates another area that something could and will malfunction.

The nozzle 100 may have a generally cylindrical first tube 110 having a first end 101, a second end 102, an exterior 103 and a generally hollow interior 104. The nozzle 100 may further have a generally cylindrical second tube 120 having a first end 121, a second end 122, an exterior 123 and a generally hollow interior 124. The generally cylindrical first tube 110 may have a diameter 108 and the generally cylindrical second tube 120 may have a diameter 128. The diameter 108 of the generally cylindrical first tube 110 may be slightly larger than the diameter 128 of the generally cylindrical second tube 120 such that the exterior 123 of the generally cylindrical second tube 120 may snugly slide within the hollow interior 104 of the generally cylindrical first tube 110. A ridge (or rail) 130 located at, for example, the first end 101 and second end 102 of the generally cylindrical first tube 110 may be secured within a corresponding track 131 of the generally cylindrical second tube 120. As a result, the generally cylindrical first tube 110 may rotate with respect to the generally cylindrical second tube 120. More specifically, the generally cylindrical first tube 110 may rotate around the exterior of the generally cylindrical second tube 120.

Attached to the exterior 103 of generally cylindrical first tube 110 of the nozzle 100 may be a first handle portion 105. Attached to the generally cylindrical second tube 120 may be a second handle portion 106. The first handle portion 105 and the second handle portion 106 may allow a user to easily and securely grasp both portions of the nozzle.

The first handle portion 105 may be secured to the secured to the exterior 103 of the first cylindrical tube 110. The second handle portion 106 may be secured to the exterior 123 of the second cylindrical portion 120.

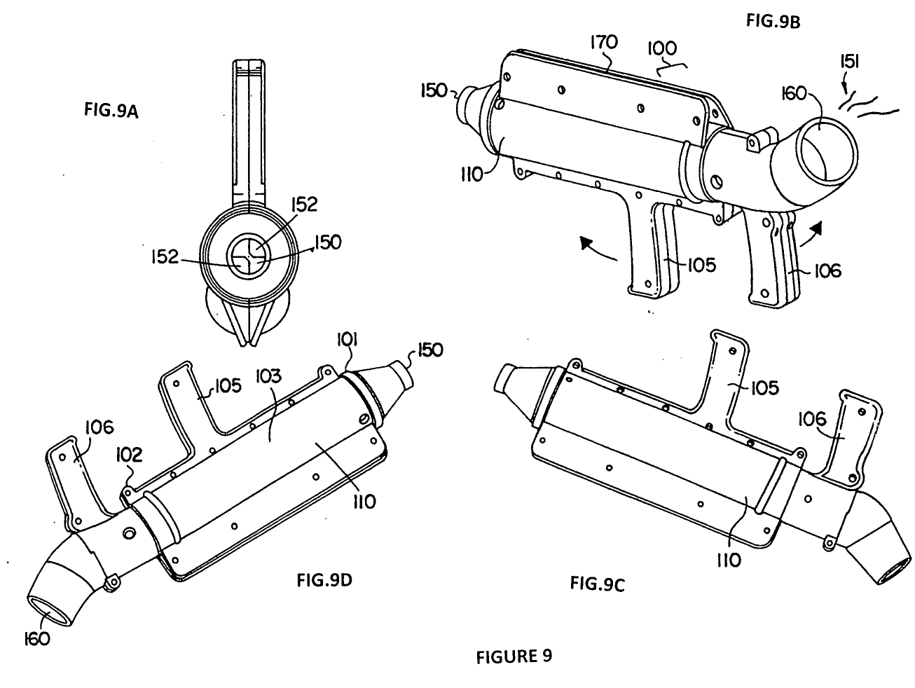

Referring now to FIGS. 9a-9d, the first cylindrical tube 110 may be secured over the second cylindrical tube 120. The first cylindrical tube 110 may have an opening 150 wherein air 151 located inside the hollow interior 104 and 124 of the tubes may exit the nozzle 100. The opening 150 of the first cylindrical tube 110 may further have a blocking portion 152 which may stop air 151 from exiting the interior of the nozzle 100 (as is discussed below).

An opening 160 at the second end 122 of the second cylindrical tube 120 may be connected to an air hose (not illustrated). When air 151 is forced through the air hose under pressure the air 151 enters the interior of the nozzle 100. A user may aim the nozzle 100 so that air 151 exiting the opening 150 of the first cylindrical tube 110 is forced out under pressure and onto, for example, a vehicle.

The first cylindrical tube 110 may further have an elongated opening 170 which may allow air 151 located in the interior of the nozzle 100 to exit the nozzle 10. The elongated opening 170 may allow air 151 to exit in a “blade-like” manner. As a result, the user may force air 151 out in a predictable long pattern. The blade-like pattern may allow the user to dry their vehicle in an easy and efficient manner.

As stated above, the first cylindrical tube 100 may rotate with respect to the second cylindrical tube 120. More specifically, the first handle portion 105 of the first cylindrical tube 110 may rotate away from the second handle 106 of the second cylindrical tube 120 while the actual “tube” portions of both units remain in roughly the same geographic area.

To rotate the first cylindrical tube 110 around the second cylindrical tube 120 the user may lace one hand on the first handle 105 and a second hand on the second handle 106. By moving his/her hands toward or away from each other the user can rotate the first cylindrical tube around the second cylindrical tube 120.

The second cylindrical tube 120 may have a series of slits 200 which may allow the flow of air 151 to exit the interior of the nozzle 100. The slits 200 are not visible in the assembled nozzle 100 as a result of being obscured by the first cylindrical tube 120. The elongated opening 17 of the first cylindrical tube 110 may be in communication with the interior of the first cylindrical tube 110 such that air 151 located within the interior of the first cylindrical tube 110 may exit through the elongated opening 170.

When the first cylindrical tube 110 is located on top of the second cylindrical tube 120 (is in the case in the working model) the slits 220 of the second cylindrical tube 120 may be either blocked by the interior wall of the first cylindrical tube 110 or the slits 200 may line up with the elongated opening 170 of the first cylindrical tube 110. If the slits 200 of the second cylindrical tube 120 are blocked by the interior wall of the first cylindrical tube 110 air 151 may not escape through the slits 200. If the slits 200 of the second cylindrical tube 120 line up with the elongated opening 170 of the first cylindrical tube 110 air 151 may flow from the interior of the nozzle 100 through the slits 200 and out the elongated opening 170 in a blade-like manner.

If the slits 200 of the second cylindrical tube 120 are blocked by the interior wall of the first cylindrical tube 110 the air 151 located in the nozzle 100 may be forced to exit the nozzle 100 via the opening 150 at the first end 101 of the first cylindrical tube 110. By rotating the nozzle 100 from a first position to a second position the user decide if the air 151 will exit the interior of the nozzle 100 by the elongated opening 170 or the opening 150 at the first end 101 of the first cylindrical tube 110. Therefore, the user can decide if the air 151 should exit in a pin point manner or a blade-like manner.

As stated above, the opening 150 of the first cylindrical tube 110 may have a blocking portion 152. In an embodiment, the blocking portion 152 may cover approximately fifty percent of the opening 150. In addition, the second cylindrical tube 120 may have a blocking portion 153. When the first blocking portion 152 and the second blocking portion 153 are aligned on directly on top of each other air 151 may exit the interior of the nozzle 100 through the opening 150 at the first end 101 of the first cylindrical tube 110. When the first cylindrical tube 110 is rotated with respect to the second cylindrical tube 120 the first blocking portion 152 may move with respect to the second blocking portion 153 such that substantially the entire opening 150 is block and air 151 cannot escape out the interior of the nozzle 100 through the opening 150. When the first blocking portion 152 and the second blocking portion 153 substantially block the entire opening 150, the slits 200 of the second cylindrical tube 120 may align with the elongated opening 170 so that air 151 is forced out the elongated opening. When the first blocking portion 152 and the second blocking portion 153 are aligned on top of each other the slits 200 of the second cylindrical tube 120 may be clocked by the interior wall of the first cylindrical tube 110. As such, air 151 may either flow out of the opening 150 at the first end 101 of the first cylindrical tube 100 or air 151 may flow out of the elongated opening 170.

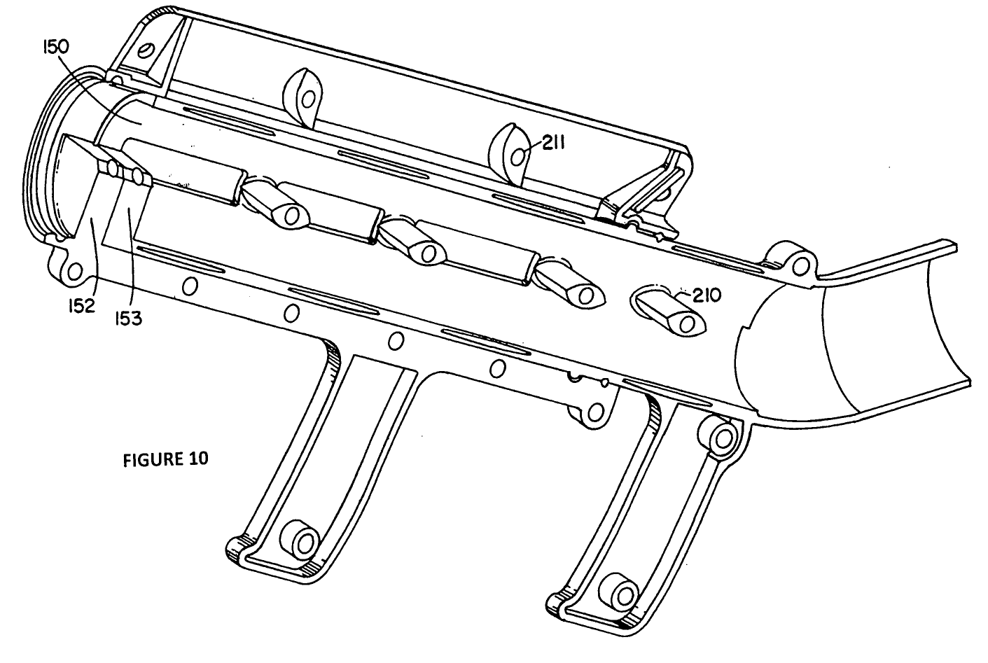

Referring now to FIG. 10, the support braces 210 and 211 of the nozzle 100 may be shaped such that air 151 flowing around the support braces 210 and 211 do not disturb the even flow of the air 151. As a result, the nozzle 100 may evenly remove water or moisture from, for example, a vehicle.

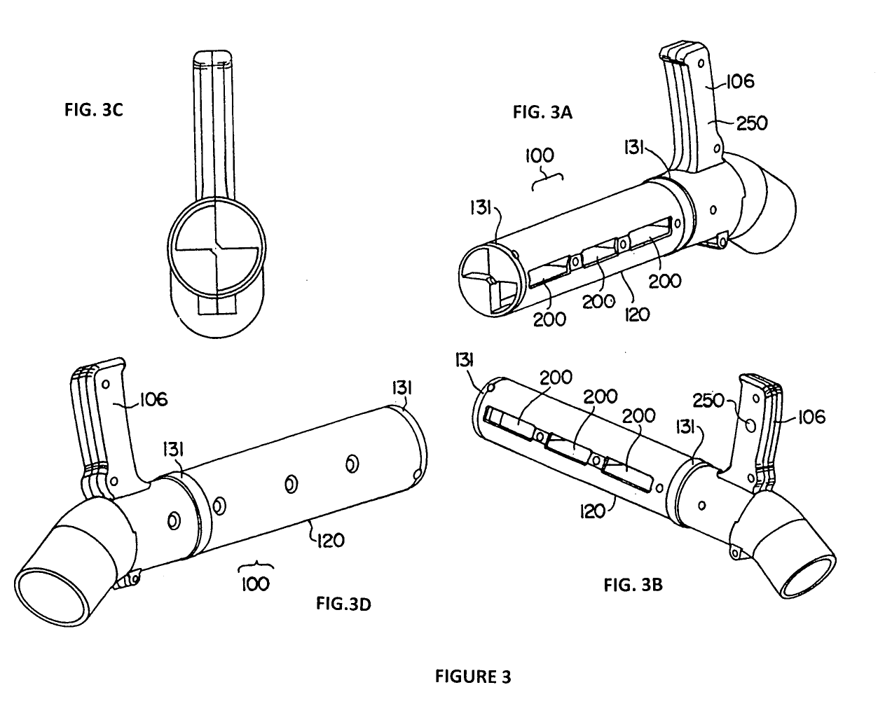

Finally, the first handle 105 or the second handle 106 (FIG. 3 illustrates the second handle) may have an automatic shut off whereby the device will not operate if the button is not pressed. As a result, if a user, for example, drops the nozzle 100 air flow through the device will be stopped and the device will not flop around dangerously on the ground.

Although embodiments of the present invention are shown and described therein, it should be understood that various changes and modifications to the presently preferred embodiments will be apparent to those skilled in the art. Such changes and modifications may be made without departing from the spirit and scope of the present invention and without diminishing its attendant advantages. It is, therefore, intended that such changes and modifications be covered by the appended claims.

1) An air nozzle comprising:
a first cylindrical tube having a first end, a second end, an interior and a handle;
a second cylindrical tube having a first end, a second end, an interior and a handle wherein a portion of the first cylindrical tube covers a portion of the second cylindrical tube wherein the first cylindrical tube may rotate with respect to the second cylindrical tube;
an inlet air opening located at the second end of the second cylindrical tube wherein air is forced into the interior of the second cylindrical tube through the inlet air opening;
a slit located on the second cylindrical tube; and
an opening at the first end of the first cylindrical tube wherein air may exit the interior of the first cylindrical tube and the second cylindrical tube through either the slit or the opening at the first end of the first cylindrical tube.

2) The nozzle of claim 1 further comprising;
an automatic shut off button which shuts off the device if not pressed.

3) The nozzle of claim 1 further comprising:
a plurality of aerodynamically shaped support posts located within the interior of the nozzle wherein the aerodynamically shaped support posts minimize the disturbance of air around the posts.
